(19) United States
(12) Patent Application Publication
(10) Pub. No.: US 2024/0297402 A1
(43) Pub. Date: Sep. 5, 2024

(54) COMPARTMENTALIZED TRACTION BATTERY PACK AND COMPARTMENTALIZING METHOD

(71) Applicant: Ford Global Technologies, LLC, Dearborn, MI (US)

(72) Inventors: Mohammadreza Eftekhari, Novi, MI (US); Kevin Durand Byrd, Novi, MI (US); Giriraj Srinivasan, Troy, MI (US); Bhaskara Rao Boddakayala, Troy, MI (US)

(21) Appl. No.: 18/176,643

(22) Filed: Mar. 1, 2023

(51) Int. Cl. H01M 50/383; B60L 50/64; H01M 50/211; H01M 50/271; H01M 50/293

(52) U.S. Cl. CPC H01M 50/383; B60L 50/64; H01M 50/211; H01M 50/271; H01M 50/293; B60L 50/66; H01M 2220/20

(57) ABSTRACT

A traction battery pack assembly includes an enclosure assembly that provides an interior area, at least one cell stack having a plurality of battery cell groups and a plurality of dividers disposed along a cell stack axis, and a plurality of compressible barriers attached to the enclosure assembly. Each compressible barrier within the plurality of compressible barriers is configured to contact a respective divider within the plurality of dividers.

### TECHNICAL FIELD

This disclosure relates generally to compartmentalizing areas of a traction battery pack to facilitate venting battery cells of the traction battery pack.

### BACKGROUND

A traction battery pack of an electrified vehicle can include groups of battery cells arranged in one or more cell stacks. From time to time, pressure and thermal energy within one or more of the battery cells can increase. In response, gases and debris can be released from those battery cells.

### SUMMARY

In some aspects, the techniques described herein relate to a traction battery pack assembly, including: an enclosure assembly that provides an interior area; at least one cell stack having a plurality of battery cell groups and a plurality of dividers disposed along a cell stack axis; and a plurality of compressible barriers attached to the enclosure assembly, each compressible barrier within the plurality of compressible barriers configured to contact a respective divider within the plurality of dividers.

In some aspects, the techniques described herein relate to a traction battery pack assembly, wherein the plurality of compressible barriers are foam compressible barriers.

In some aspects, the techniques described herein relate to a traction battery pack assembly, wherein the plurality of compressible barriers include rubber.

In some aspects, the techniques described herein relate to a traction battery pack assembly, wherein the plurality of compressible barriers are attached to the enclosure assembly with adhesive.

In some aspects, the techniques described herein relate to a traction battery pack assembly, wherein the enclosure assembly includes an enclosure cover, the plurality of compressible barriers attached to an underside of the enclosure cover.

In some aspects, the techniques described herein relate to a traction battery pack assembly, wherein each divider within the plurality of dividers separates a first group of battery cells within the plurality of battery cells from a second group of battery cells within the plurality of battery cells.

In some aspects, the techniques described herein relate to a traction battery pack assembly, wherein each compressible barrier within the plurality of compressible barriers is axially aligned with one of the dividers within the plurality of dividers along the cell stack axis.

In some aspects, the techniques described herein relate to a traction battery pack assembly, wherein each compressible barrier within the plurality of compressible barriers is compressed against one of the dividers within the plurality of dividers along the cell stack axis.

In some aspects, the techniques described herein relate to a traction battery pack assembly, wherein each compressible barrier within the plurality of compressible barriers is configured to block vent byproducts expelled from the first group of battery cells from moving adjacent to the second group of battery cells.

In some aspects, the techniques described herein relate to a traction battery pack assembly, wherein each compressible barrier within the plurality of compressible barriers extends longitudinally in a direction that is transverse to the cell stack axis.

In some aspects, the techniques described herein relate to a traction battery pack assembly, wherein each compressible barrier within the plurality of compressible barriers is compressed against one of the dividers within the plurality of dividers.

In some aspects, the techniques described herein relate to a traction battery pack assembly, wherein the plurality of compressible barriers are detached from the plurality of compressible barriers.

In some aspects, the techniques described herein relate to a method of compartmentalizing a battery pack, including: within an enclosure assembly, compressing a compressible barrier against a divider within a cell stack to block vent byproducts expelled from at least one first battery cell within a cell stack from flowing adjacent to at least one second battery cell within the cell stack.

In some aspects, the techniques described herein relate to a method, wherein the divider is disposed between the at least one first battery cell and the at least one second battery cell along a cell stack axis of the cell stack.

In some aspects, the techniques described herein relate to a method, wherein the compressible barrier is attached directly to the enclosure assembly.

In some aspects, the techniques described herein relate to a method, wherein the compressible barrier is attached directly to an underside of an enclosure cover of the enclosure assembly.

In some aspects, the techniques described herein relate to a method, wherein the compressible barrier is foam.

In some aspects, the techniques described herein relate to a method, wherein the compressible barrier is adhesively attached to the enclosure assembly.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an example electrified vehicle.

FIG. 2 illustrates an expanded, perspective view of a battery pack from the electrified vehicle of FIG. 1 and schematically showing cell stacks of the battery pack.

FIG. 3 illustrates a section view taken at line 3-3 in FIG. 2.

FIG. 3A illustrates a close-up of an area of FIG. 3.

FIG. 4 illustrates an underside of an enclosure cover from the battery pack of FIG. 2.

### DETAILED DESCRIPTION

This disclosure details exemplary methods and systems of compartmentalizing an enclosure of a traction battery pack. The compartmentalizing can help to contain and direct gas and debris vented from one or more battery cells during a thermal event. Guiding the vented gas and debris away from other battery cells—other battery cells that are not venting—can help to prevent the thermal event from cascading to those other battery cells.

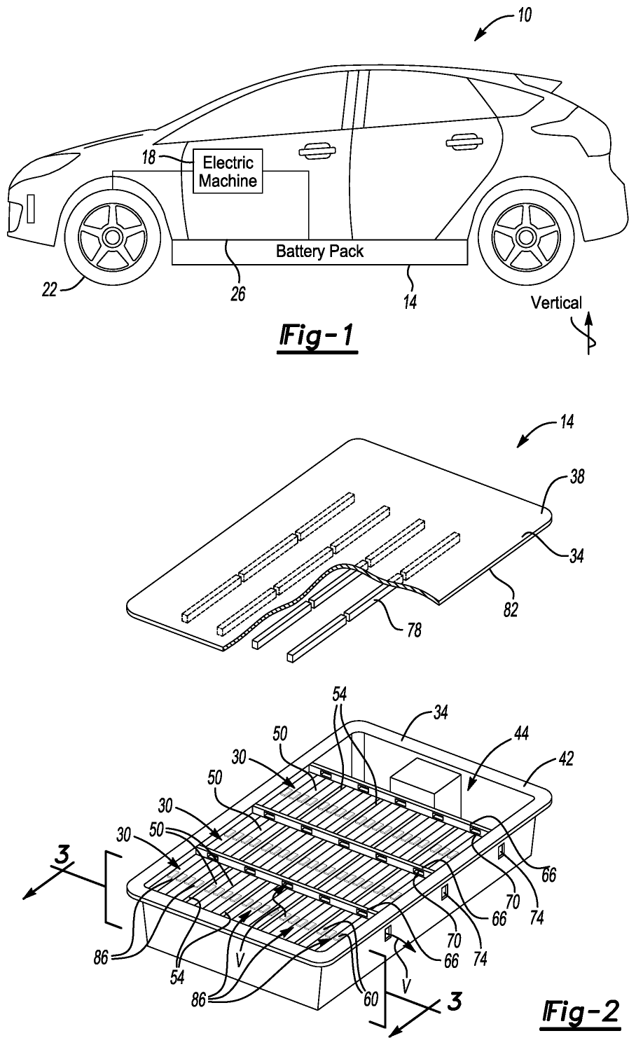

With reference to FIG. 1, an electrified vehicle 10 includes a battery pack 14, an electric machine 18, and wheels 22. The battery pack 14 powers an electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

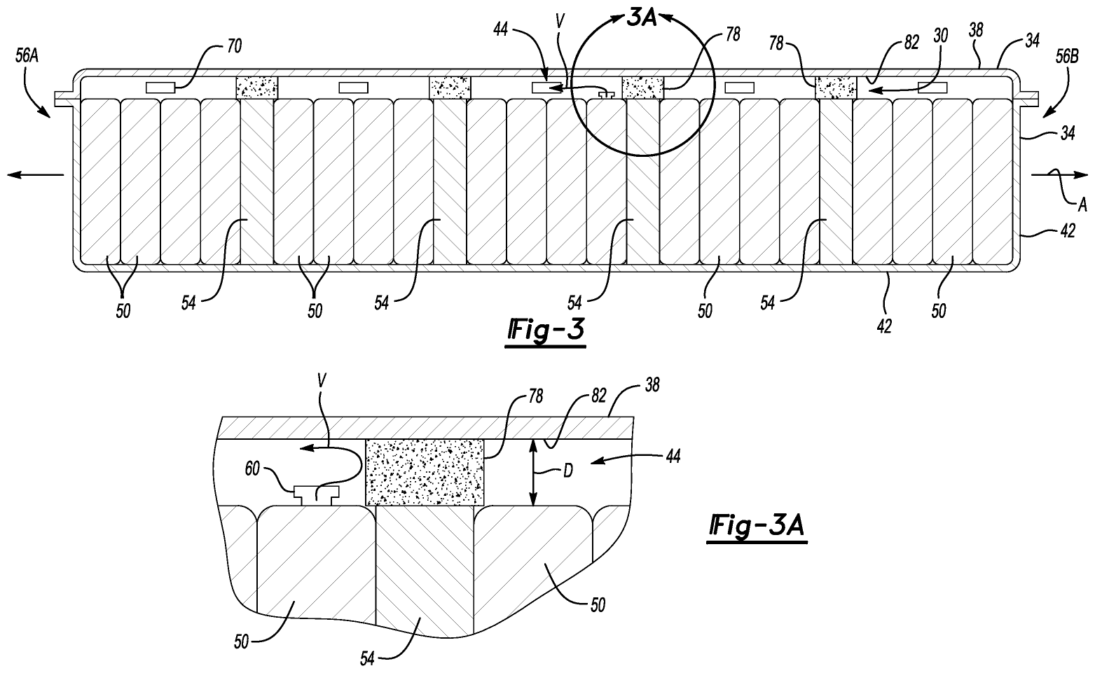

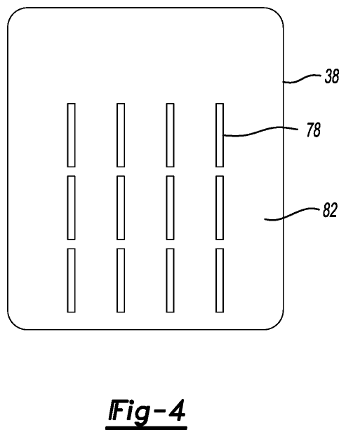

With reference now to FIGS. 2-4, the battery pack 14 includes a plurality of cell stacks 30 held within an enclosure assembly 34. In the exemplary embodiment, the enclosure assembly 34 includes an enclosure cover 38 and an enclosure tray 42. The enclosure cover 38 is secured to the enclosure tray 42 to provide an interior area 44 that houses the cell stacks 30. The enclosure cover 38 can be secured to the enclosure tray 42 using mechanical fasteners (not shown), for example.

Each of the cell stacks 30 includes a plurality of battery cells 50 (or simply, “cells”) and at least one divider 54 distributed along a respective cell stack axis A. The cell stacks 30 each extend from a first axial end 56A to an opposite, second axial end 56B.

Within each cell stack 30, the battery cells 50 are stacked side-by-side relative to each other along the cell stack axis A. The battery cells 50 store and supply electrical power. Although specific numbers of the cell stacks 30 and cells 50 are illustrated in the various figures of this disclosure, the battery pack 14 could include any number of the cell stacks 30 having any number of individual cells 50.

In an embodiment, the battery cells 50 are lithium-ion pouch cells. However, battery cells having other geometries (cylindrical, prismatic, etc.) other chemistries (nickel-metal hydride, lead-acid, etc.), or both could alternatively be utilized within the scope of this disclosure.

From time to time, pressure and thermal energy within one or more of the battery cells 50 can increase. The pressure and thermal energy increase can be due to an overcharge condition, for example. The pressure and thermal energy increase can cause the associated battery cell 50 to rupture and release vent byproducts, such as gas and debris, from within the battery cell 50.

The vent byproducts can be released from the associated battery cell 50 through a designated vent 60 within the housing, such as a membrane that yields in response to increased pressure, or through a ruptured area of the associated battery cell 50.

The battery pack 14, in these examples, includes cross-member assemblies 66 disposed between cell stacks 30. The example cross-member assemblies 66 extend longitudinally in a direction that is parallel to the cell stack axes A. The cross-member assemblies 66 and the cell stack axes A extend in a cross-vehicle direction (i.e., from a driver side to a passenger side).

In this example, the cross-member assemblies 66 include venting passageways and openings 70 to the venting passageways. Vent byproducts vented through the vent 60 of one or more of the battery cells 50 can move through at least one of the openings 70 into venting passageway. The gas and debris are communicated though the venting passageway through an enclosure vent 74 to an area outside the battery pack 14. The openings 70, the enclosure vent 74, or both can be covered by respective membranes, for example, when venting is not needed. During venting, the vent byproducts can rupture the membranes so that the vent byproducts can flow from the battery 50, through the openings 70 to the venting passageway and then through the enclosure vent 74.

To help direct the gas and debris outward for the cell stack axis A though the openings 70 rather than along the axis adjacent to other battery cells 50, barriers 78 are secured to the enclosure assembly 34. In this example, the barriers 78 are secured to an underside 82 of the enclosure cover 38 of the enclosure assembly 34.

The barriers 78 are compressible barriers. The barriers 78 can be foam or rubber, for example. The barriers 78 are attached directly to the enclosure assembly 34 with adhesive in this example. The barriers 78 can be considered PIA with the enclosure assembly 34. The barriers 78 each extend longitudinally in a direction that is transverse, here perpendicular, to the cell stack axes A.

Each barrier 78 axially aligned with one of the divider 54 along a respective one of the cell stack axes. When the enclosure cover 38 is secured to the enclosure tray 42, the barriers 78 contact, and compress against, a respective one of the dividers 54. This compartmentalizes groups of battery cells 50 within the cell stacks 30. The barriers 78 can be slightly oversized relative to a dimension D between the tops of the dividers 54 and the underside 82 of the enclosure cover 38 to ensure good contact and compression of the barriers 78. In this example, the barriers 78 are detached from the dividers 54. In other examples, an adhesive could be used to secure the barriers 78 to the dividers 54.

Due to the barriers 78, when one or more of the battery cells 50 vent, the vent byproducts V contact the barriers 78 and is redirected so that the vent byproducts V. flow through the openings 70 in the cross-member assemblies 66 rather than adjacent to other battery cells 50 in the cell stack 30. Vent byproducts V flowing adjacent to other battery cells 50 can increase thermal energy levels in those battery cells 50 and lead to a cascading thermal event.

Each of the barriers 78 is configured to block vent byproducts expelled from the first group of battery cells from moving adjacent to the second group of battery cells.

In this example, the dividers 54 and the barriers 58 separate groups of four battery cells 50 within a given one of the cell stacks 30 from other groups of four battery cells 50 within that cell stack 30. Thus, vent products V from a venting battery cell 50 flow adjacent to, at most, three other battery cells 50 within that group before moving through the openings 70.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
an enclosure assembly that provides an interior area;
at least one cell stack having a plurality of battery cell groups and a plurality of dividers disposed along a cell stack axis; and
a plurality of compressible barriers attached to the enclosure assembly, each compressible barrier within the plurality of compressible barriers configured to contact a respective divider within the plurality of dividers.

2. The traction battery pack assembly of claim 1, wherein the plurality of compressible barriers are foam compressible barriers.

3. The traction battery pack assembly of claim 1, wherein the plurality of compressible barriers comprise rubber.

4. The traction battery pack assembly of claim 1, wherein the plurality of compressible barriers are attached to the enclosure assembly with adhesive.

5. The traction battery pack assembly of claim 1, wherein the enclosure assembly includes an enclosure cover, the plurality of compressible barriers attached to an underside of the enclosure cover.

6. The traction battery pack assembly of claim 1, wherein each divider within the plurality of dividers separates a first group of battery cells within the plurality of battery cells from a second group of battery cells within the plurality of battery cells.

7. The traction battery pack assembly of claim 6, wherein each compressible barrier within the plurality of compressible barriers is axially aligned with one of the dividers within the plurality of dividers along the cell stack axis.

8. The traction battery pack assembly of claim 6, wherein each compressible barrier within the plurality of compressible barriers is compressed against one of the dividers within the plurality of dividers along the cell stack axis.

9. The traction battery pack assembly of claim 6, wherein each compressible barrier within the plurality of compressible barriers is configured to block vent byproducts expelled from the first group of battery cells from moving adjacent to the second group of battery cells.

10. The traction battery pack assembly of claim 1, wherein each compressible barrier within the plurality of compressible barriers extends longitudinally in a direction that is transverse to the cell stack axis.

11. The traction battery pack assembly of claim 1, wherein each compressible barrier within the plurality of compressible barriers is compressed against one of the dividers within the plurality of dividers.

12. The traction battery pack assembly of claim 1, wherein the plurality of compressible barriers are detached from the plurality of compressible barriers.

13. A method of compartmentalizing a battery pack, comprising:
within an enclosure assembly, compressing a compressible barrier against a divider within a cell stack to block vent byproducts expelled from at least one first battery cell within a cell stack from flowing adjacent to at least one second battery cell within the cell stack.

14. The method of claim 13, wherein the divider is disposed between the at least one first battery cell and the at least one second battery cell along a cell stack axis of the cell stack.

15. The method of claim 13, wherein the compressible barrier is attached directly to the enclosure assembly.

16. The method of claim 13, wherein the compressible barrier is attached directly to an underside of an enclosure cover of the enclosure assembly.

17. The method of claim 13, wherein the compressible barrier is foam.

18. The method of claim 13, wherein the compressible barrier is adhesively attached to the enclosure assembly.
